(19) United States
(12) Patent Application Publication
(10) Pub. No.: US 2021/0107390 A1
(43) Pub. Date: Apr. 15, 2021

(54) STORAGE COMPARTMENT CARGO MANAGEMENT ASSEMBLY

(71) Applicant: GM GLOBAL TECHNOLOGY OPERATIONS LLC, Detroit, MI (US)

(72) Inventors: Sadanand N. Raikar, Bangalore (IN); Jeffrey J. Schultz, Grand Blanc, MI (US); Mark A. Voss, Richmond, MI (US); Mukesh Amin, Canton, MI (US)

(73) Assignee: GM GLOBAL TECHNOLOGY OPERATIONS LLC, Detroit, MI (US)

(21) Appl. No.: 16/600,979

(22) Filed: Oct. 14, 2019

(51) Int. Cl. B60P 1/64

(52) U.S. Cl. CPC B60P 1/6409; B60P 1/649; B60P 1/6436

(57) ABSTRACT

A cargo storage compartment of a motor vehicle is arranged along a vehicle central axis. The cargo storage compartment includes a first side-wall and a second side-wall, each arranged parallel to the vehicle central axis, and a floor, together defining width, length, and height of the storage compartment. The cargo storage compartment also includes a cargo management assembly for moving objects in the cargo storage compartment along the vehicle central axis. The cargo management assembly also includes a first guide rail and a second guide rail arranged along the respective first and second side-walls. The assembly additionally includes a panel arranged between the first and second side-walls and transverse to the vehicle central axis. The panel is movably mounted on a panel axis to each of the first and second guide rails. The assembly further includes a mechanism configured to shift the panel along the first and second guide rails.

### INTRODUCTION

The disclosure relates to an assembly for managing, such as moving cargo in a storage compartment of a motor vehicle.

Motor vehicles come in a variety of configurations. For example, an automobile is a motor vehicle focused primarily on transporting passengers and their belongings, while a pick-up truck is a motor vehicle specifically designed for transporting cargo, such as materials and equipment.

Both automobiles and pick-up trucks have storage compartments. In the case of an automobile, the storage compartment is a trunk with access thereto typically covered by a pivoting lid, while in the case of a pick-up truck, the storage compartment is typically an open-top pick-up truck bed. A pickup truck bed typically employs a tail-gate to close off the bed for retaining cargo therein. Such a tail-gate is generally pivotably attached to one end of the bed for access to cargo. The ease of loading and unloading storage compartments of both automobiles and pick-up trucks generally depends on the particular compartment's size and access to the farthest reaches from the nearest access opening into the compartment.

### SUMMARY

A cargo storage compartment of a motor vehicle is arranged along a vehicle central axis. The cargo storage compartment includes a first side-wall and a second side-wall, each arranged parallel to the vehicle central axis, and a floor, which together define a width, a length, and a height or depth of the cargo storage compartment. The cargo storage compartment also includes a cargo management assembly configured to move objects in the cargo storage compartment along the vehicle central axis. The cargo management assembly also includes a first guide rail arranged along the first side-wall and a second guide rail arranged along the second side-wall. The cargo management assembly additionally includes a panel arranged between the first and second side-walls and transverse to the vehicle central axis. The panel is movably mounted on a panel axis to each of the first guide rail and the second guide rail. The cargo management assembly further includes a mechanism configured to shift the panel along the first and second guide rails.

The motor vehicle may be a pick-up truck having a road wheel. In such a vehicle, the cargo storage compartment may be a pick-up truck bed. The pick-up truck bed may define a wheelhouse extending over the road wheel and intruding into the width of the pick-up truck bed. The panel may be configured to traverse over and clear the wheelhouse.

The panel may include a collapsible section configured to traverse over and clear the wheelhouse.

The panel may be configured to pivot on the panel axis with respect to the first and second guide rails to thereby traverse over and clear the wheelhouse.

The mechanism may include a drive unit configured to generate a torque to shift the panel, such as, for example, via a belt, chain, cable, or screw drive.

The drive unit may include a pulley configured to shift the panel and an actuation handle configured to drive the pulley.

The drive unit may include an electric motor configured to shift the panel.

The drive unit may be arranged along one of the first guide rail and the second guide rail. The mechanism may additionally include a transfer shaft arranged perpendicular to the vehicle central axis and configured to transmit the torque of the drive unit from one of the first and second guide rails to the other of the first and second guide rails.

The mechanism may include either a screw drive or a rack and pinion.

The mechanism may include a positive stop or a limit switch, each configured to restrict travel distance of the panel with respect to the length of the cargo storage compartment.

A pick-up truck employing the aforementioned cargo management assembly is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a vehicle having a storage compartment, specifically illustrated as a bed of a pick-up truck, that includes an integrated, cargo management assembly, according to the disclosure.

FIG. 2 is a schematic close-up partial rear top perspective view of the vehicle shown in FIG. 1, illustrating a crank-operated cable drive configured to shift the cargo management assembly, according to the disclosure.

FIG. 3 is a schematic close-up partial rear top perspective view of the vehicle shown in FIG. 1, illustrating a screw-drive mechanism configured to operate the cargo management assembly, according to the disclosure.

FIG. 4 is a schematic close-up partial rear top perspective view of the vehicle shown in FIG. 1, illustrating a rack and pinion mechanism configured to operate the cargo management assembly, according to the disclosure.

### DETAILED DESCRIPTION

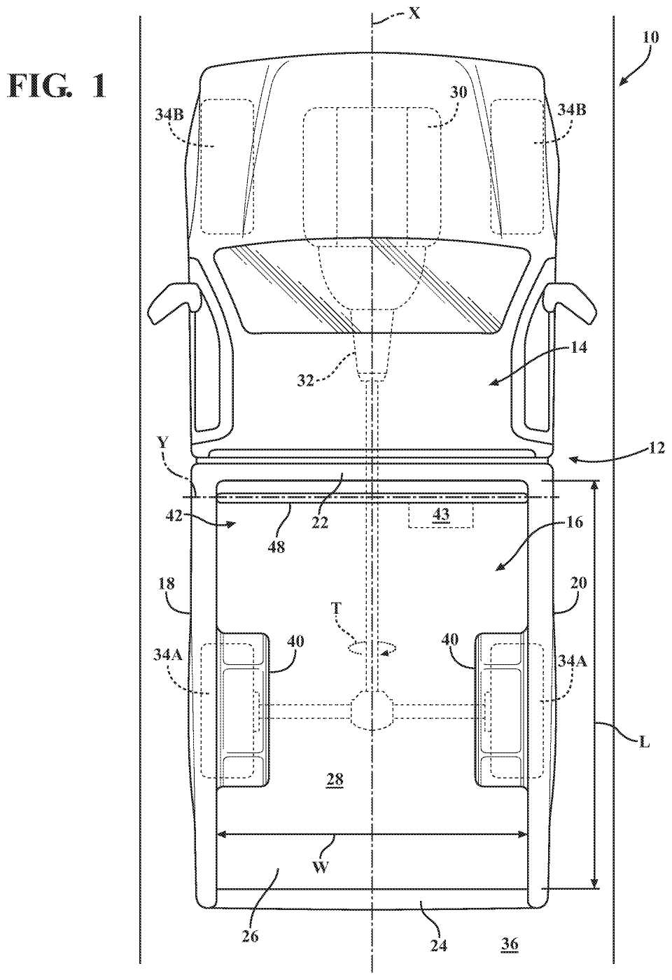

Referring to the drawings, wherein like reference numbers refer to like components, FIG. 1 shows a vehicle 10 depicted as a truck. The vehicle 10 includes a vehicle body structure 12. The vehicle body structure 12 defines a passenger compartment 14 and a cargo storage compartment 16. As shown in FIG. 1, the passenger compartment 14 is depicted as a truck cab, while the storage compartment 16 is configured as a truck bed that is generally adapted to carry bulky cargo.

As understood by those skilled in the art, in general, a truck is a motor vehicle designed to transport cargo. Trucks vary greatly in size, power, and configuration, with the smallest being mechanically and dimensionally similar to an automobile. Commercial trucks, on the other hand, may be significantly larger and more powerful than their light truck counterparts, and may be configured to transport heavier loads and specialized equipment. A truck, such as disclosed in FIG. 1, is typically a light duty truck having an enclosed cab and an open cargo area with low sides and tail-gate. Although the vehicle 10 is specifically illustrated and described as a truck, nothing precludes the vehicle 10 from being configured as an automobile, i.e., primarily designed to transport passengers, or any other road-going wheeled vehicle.

A vehicle longitudinal or central axis X extends through the passenger compartment 14 and the cargo storage compartment 16. As shown in FIG. 1, the storage compartment 16 is enclosed on four sides and is illustrated as a truck bed. Specifically, the cargo storage compartment 16 includes a plurality of generally vertical perimeter walls, shown as a first or left side-wall 18 and a second or right side-wall 20, each arranged generally parallel to the axis X. The first side-wall 18 is arranged on one side of the axis X and is configured as a left side-wall of the bed, while the second side-wall 20 is arranged on the other side of the axis X, and is therefore configured as a right side-wall. The cargo storage compartment 16 shown in FIG. 1 also includes a third side-wall or front wall 22, a fourth side-wall or tail-gate 24, and a floor 26. In the embodiment of the vehicle 10 configured as an automobile (not shown), the cargo storage compartment 16 may be an enclosed trunk, further having a top wall constraining the height of the compartment, and wherein the fourth side-wall may be a trunk lid. Although the enclosed automobile trunk embodiment of cargo storage compartment 16 is within the scope of the present disclosure, for simplicity the remainder of the following description will focus on the truck bed embodiment.

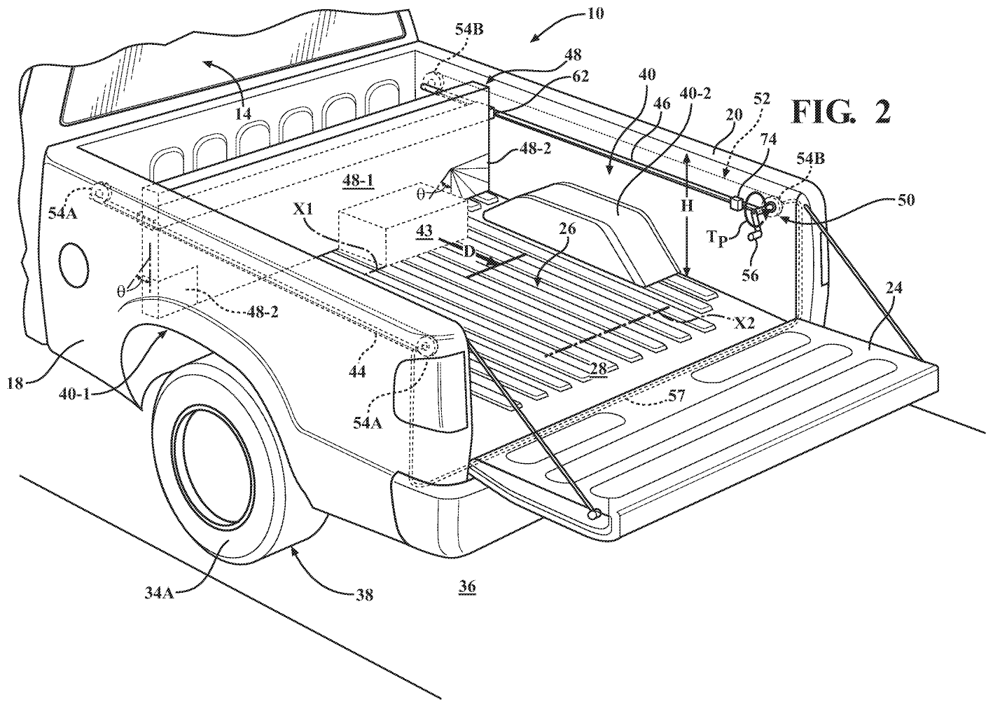

The front wall 22 and the tail-gate 24 are arranged substantially parallel to each other, similar to the arrangement of the left side-wall 18 relative to the right side-wall 20. The side-walls 18, 20, the front wall 24, and the floor 26 together at least partially define a cargo area 28. As shown in FIG. 1, the tail-gate 24 may be operatively, for example, pivotably, connected to the side-walls 18 and 20 to selectively restrict access to the cargo storage compartment 16 and facilitate loading and unloading cargo therefrom. The first side-wall 18 and the second side-wall 20, along with the third side-wall 22, the tail-gate 24, and the floor 26, together define a width W, a length L (shown in FIG. 1), and a depth or height H (shown in FIG. 2), of the cargo storage compartment 16. As shown in FIGS. 1-4, the cargo storage compartment 16 also includes a cargo management assembly 42.

As shown in FIG. 1, the vehicle 10 also includes a power-source 30 configured to propel the vehicle via power-source torque T. The power-source 30 may be an internal combustion engine, an electric motor-generator, or a combination thereof acting through a transmission 32 to deliver the power-source torque T to one or more road wheels 34A. The road wheels 34A may be configured as vehicle driven wheels to receive and apply the power-source torque T to a road surface 36 at a frictional interface 38 therewith, as shown in FIGS. 1-4. The cargo storage compartment 16 is arranged over the road wheels 34A. As shown, the vehicle 10 is rear-wheel-drive, in other words, the road wheels 34A are arranged under the storage compartment 16. In a separate embodiment of the vehicle 10, the road wheels 34A may be the vehicle's road wheels that are not configured to receive the torque T from the power-source 30 (not shown). In such an embodiment, the vehicle 10 may be front-wheel-drive, and the road wheels 34B may be configured to receive the torque T. The vehicle 10 may also be configured as all-wheel-drive, where the road wheels 34A and 34B receive some portion of the torque T.

The cargo storage compartment 16 includes a wheelhouse 40 configured to extend over each of the road wheels 34A. Each wheelhouse 40 includes a surface 40-1 facing the driven wheel 34A, and also includes an opposite surface 40-2 facing the cargo area 28. As may be seen from FIGS. 1-4, each wheelhouse 40 is arranged inside the cargo storage compartment 16 such that the wheelhouse extends into the cargo area 28 and permits the respective driven wheels 34A to remain generally within confines of the vehicle body structure 12. As additionally shown, the wheelhouse 40 may be formed partially into one of the side-walls 18, 20 and partially into the floor 26. Accordingly, as may be seen from FIG. 1, each wheelhouse 40 locally intrudes into the width W of the cargo storage compartment 16.

The cargo management assembly 42 is configured, i.e., designed and constructed, to move objects, such as the object 43 shown in FIGS. 1-4, in the cargo storage compartment 16 along the vehicle central axis X. The cargo management assembly 42 includes a first guide rail 44 arranged along the first side-wall 18 and a second guide rail 46 arranged along the second side-wall 20. The cargo management assembly 42 also includes a panel 48 arranged between the first side-wall 18 and the second side-wall 20. The panel 48 is also movably mounted on a panel axis Y transverse to the vehicle central axis X. The panel 48 is also movably mounted to each of the first guide rail 44 and the second guide rail 46. As shown in FIGS. 1-4, the cargo management assembly 42 additionally includes a mechanism 50 configured to shift the panel 48 along the first and second guide rails 44, 46, from the front wall 22 toward the tail-gate 24 and back. The first and second guide rails 44, 46 may be arranged within, such as embedded in, the respective first and second side-walls 18, 20, and/or along the side-walls within the floor 26.

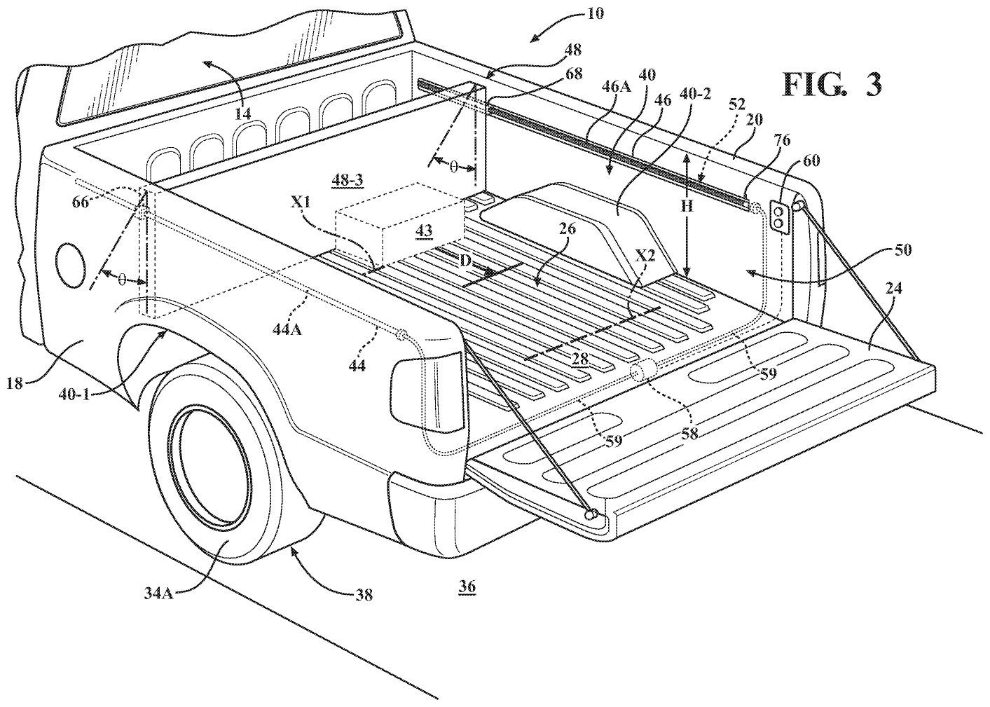

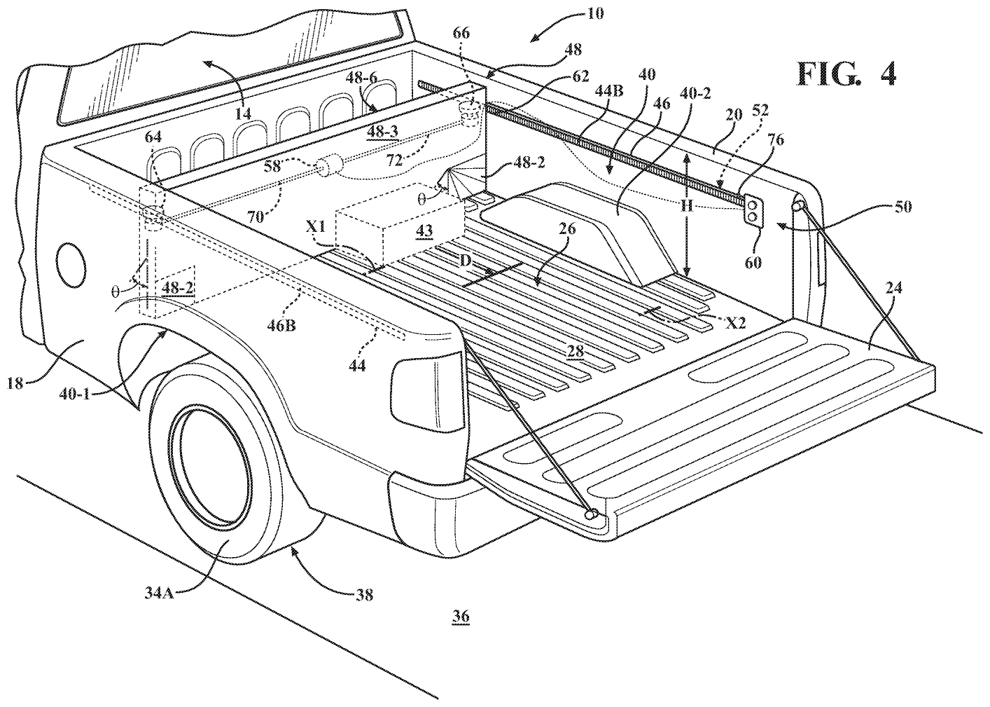

The panel 48 may be configured to travel between the front wall 22 and the wheelhouse(s) 40. Alternatively, the panel 48 may be configured to traverse over and clear the wheelhouse 40 as the panel is moved in the cargo storage compartment 16 along the vehicle central axis X and travel to within a predetermined distance of the tail-gate 24. As shown in FIG. 2, the panel 48 may include a generally rigid main body or substantially central section 48-1 and, to traverse over and clear the wheelhouse 40, collapsible, flexible, or pivotable sections 48-2 mounted to the main body. Alternatively, as shown in FIGS. 3 and 4, the panel 48 may include a pivotable main body 48-3. In such an embodiment, the panel main body 48-1 may be configured to hinge and pivot on the panel axis Y through an angle θ with respect to the first and second guide rails 44, 46 to thereby traverse over and clear the wheelhouse 40. Additionally, the angle θ of the pivoting action of the main body 48-3 with respect to the left and right side-walls 18, 20 may be restricted via a physical travel limiter (not shown). The main body 48-3 may be hinged proximate the floor 26. In such a configuration, the panel 48 may pivot at the floor 26, and thereby fold down to a position parallel the floor when not in use. The panel 48 may additionally be height adjustable, i.e., relative to the height H of the cargo storage compartment 16, thus configured to select the size of the objects 43 that may be cleared by or moved via the panel.

The mechanism 50 may include a drive unit 52 configured to generate a torque Tₚ to shift the panel 48. The drive unit 52 may be configured to shift the panel 48 from the front wall 22 to the tail-gate 24 and back, from the front wall to the wheelhouse 40 and back, or from the wheelhouse to the tail-gate and back. The drive unit 52 may be configured as a cable drive (shown in FIG. 2), or a belt or chain drive (not shown). Alternatively, as shown in FIG. 3, the drive unit 52 may be configured as a screw drive with each guide rail 44, 46 including respective rotating screws 44A, 46A. In another alternative configuration, shown in FIG. 4, the drive unit 52 may be configured as a rack and pinion drive, with each guide rail 44, 46 including respective gear racks 44B, 46B. In the embodiment of the mechanism 50 shown in FIG. 2, the drive unit 52 may include pulleys 54A, 54B arranged on the guide rails 44, 46, respectively, and configured to shift the panel 48.

Additionally, the drive unit 52 may include an actuation handle 56 configured to drive one of the pulleys 54B via manual generation of the torque Tₚ. The actuation handle 56 of the drive unit 52 may be positioned proximate the tail-gate 24 within reach of an operator or user of the vehicle 10 and the cargo management assembly 42. The drive unit 52 may also include a flexible cable 57 operatively connecting the actuation handle 56 to the pulleys 54A. As shown in FIGS. 3 and 4, the drive unit 52 may include an electric motor 58 configured to shift the panel 48 via the torque Tₚ being generated by the electric motor. The embodiments of the drive unit 52 using the electric motor 58 may include a switch 60 for controlling operation of the electric motor positioned within reach of the operator. As shown in FIG. 3, in the screw drive configuration of the drive unit 52, the electric motor 58 may be operatively connected to the screws 44A, 46A via flexible cables 59. The cables 59 are intended to simultaneously turn each of the respective screws 44A, 46A, and thereby shift the panel 48 squarely along the length L of the cargo storage compartment 16.

As shown in FIG. 2, the drive unit 52 may be arranged in proximity of one of the side-walls 18, 20 and along either the first guide rail 44 or the second guide rail 46. Although the drive unit 52 is shown as being arranged proximate and along the first guide rail 44, in principle nothing precludes the drive unit from being arranged proximate and along the second guide rail 46. The mechanism 50 may additionally include a transfer shaft 62 arranged perpendicular to the vehicle central axis X substantially spanning the width W between the first and second side-walls 18, 20. The transfer shaft 62 is configured to transmit the torque Tₚ of the drive unit 52 from the position of one of the two guide rails 44 or 46 to the other of the two guide rails. As shown in FIG. 4, the rack and pinion configuration of the drive unit 52 may include a first pinion gear 64 in mesh with the gear rack 44B and a second pinion gear 66 in mesh with the gear rack 46B. In such an embodiment, the electric motor 58 may be operatively connected to the pinions 64, 66 via respective transfer shafts 70, 72 (shown in FIG. 4) to simultaneously turn each of the respective pinion gears, and thereby shift the panel 48 squarely along the length L of the cargo storage compartment 16.

The mechanism 50 may also include a positive stop 74 (shown in FIG. 2), such as physical stop feature, which may be the wheelhouse surface 40-2, or an electronic limit switch 76 (shown in FIGS. 3 and 4). Each of the positive stop 74 and the limit switch 72 is configured to restrict travel distance D of the panel 48 with respect to the length L of the cargo storage compartment 16. Specifically, the positive stop 74 or the limit switch 76 may be configured to restrict the travel distance D of the panel 48 to a position X1 between the front wall 22 and the wheelhouse(s) 40. As shown in FIGS. 2-4, the position X1 may be proximate the wheelhouse(s) 40 to facilitate shifting objects in the cargo storage compartment 16 from the front wall 22 as far toward the tail-gate 24 as location of the wheelhouse(s) permit. Alternatively, the positive stop 74 or the limit switch 76 may be configured to restrict the travel distance D of the panel 48 to a position X2 between the wheelhouse(s) 40 and the tail-gate 24. The position X2 may be proximate the tail-gate 24 to facilitate shifting objects in the cargo storage compartment 16 to within reach of the operator of the vehicle 10 and the cargo management assembly 42 from the location of the tail-gate.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A cargo storage compartment of a motor vehicle arranged along a vehicle central axis, the cargo storage compartment comprising:
a first side-wall and a second side-wall, each arranged parallel to the vehicle central axis, and a floor, which together define a width, a length, and a height of the cargo storage compartment; and
a cargo management assembly configured to move move objects in the cargo storage compartment along the vehicle central axis, the cargo management assembly including:
a first guide rail arranged along the first side-wall and a second guide rail arranged along the second side-wall;
a panel arranged between the first and second side-walls, transverse to the vehicle central axis, and movably mounted on a panel axis to each of the first guide rail and the second guide rail; and
a mechanism configured to shift the panel along the first and second guide rails.

2. The cargo storage compartment of claim 1, wherein:
the motor vehicle is a pick-up truck having a road wheel;
the cargo storage compartment is a pick-up truck bed;
the pick-up truck bed defines a wheelhouse extending over the road wheel and intruding into the width of the pick-up truck bed; and
the panel is configured to traverse over and clear the wheelhouse.

3. The cargo storage compartment of claim 2, wherein the panel includes a collapsible section configured to traverse over and clear the wheelhouse.

4. The cargo storage compartment of claim 2, wherein the panel is configured to pivot on the panel axis with respect to the first and second guide rails to thereby traverse over and clear the wheelhouse.

5. The cargo storage compartment of claim 1, wherein the mechanism includes a drive unit configured to generate a torque to shift the panel.

6. The cargo storage compartment of claim 5, wherein the drive unit includes a pulley configured to shift the panel and an actuation handle configured to drive the pulley.

7. The cargo storage compartment of claim 5, wherein the drive unit includes an electric motor configured to shift the panel.

8. The cargo storage compartment of claim 5, wherein the drive unit is arranged along one of the first guide rail and the second guide rail, and wherein the mechanism additionally includes a transfer shaft arranged perpendicular to the vehicle central axis and configured to transmit the torque of the drive unit from one of the first and second guide rails to the other guide rail of the first and second guide rails.

9. The cargo storage compartment of claim 7, wherein the drive unit includes a screw drive or a rack and pinion.

10. The cargo storage compartment of claim 1, wherein the mechanism includes a positive stop or a limit switch, each configured to restrict travel distance of the panel with respect to the length of the cargo storage compartment.

11. A pick-up truck comprising:
a power-source configured to generate a power-source torque;
a driven wheel configured to receive the power-source torque;
a pick-up truck body structure arranged along a truck central axis and defining a pick-up truck bed, wherein the pick-up truck bed includes a first side-wall and a second side-wall, each arranged parallel to the truck central axis, and a floor, which together define a width, a length, and a height of the pick-up truck bed; and
a cargo management assembly configured to move objects in the pick-up truck bed along the truck central axis, the cargo management assembly including:
a first guide rail arranged along the first side-wall and a second guide rail arranged along the second side-wall;
a panel arranged between the first and second side-walls, transverse to the truck central axis, and movably mounted on a panel axis to each of the first guide rail and the second guide rail; and
a mechanism configured to shift the panel along the first and second guide rails.

12. The pick-up truck of claim 11, wherein:
the pick-up truck bed defines a wheelhouse extending over the driven wheel and intruding into the width of the pick-up truck bed; and
the panel is configured to traverse over and clear the wheelhouse.

13. The pick-up truck of claim 12, wherein the panel includes a collapsible section configured to traverse over and clear the wheelhouse.

14. The pick-up truck of claim 12, wherein the panel is configured to pivot on the panel axis with respect to the first and second guide rails to thereby traverse over and clear the wheelhouse.

15. The pick-up truck of claim 11, wherein the mechanism includes a drive unit configured to generate a torque to shift the panel.

16. The pick-up truck of claim 15, wherein the drive unit includes a pulley configured to shift the panel and an actuation handle configured to drive the pulley.

17. The pick-up truck of claim 15, wherein the drive unit includes an electric motor configured to shift the panel.

18. The pick-up truck of claim 15, wherein the drive unit is arranged along one of the first guide rail and the second guide rail, and wherein the mechanism additionally includes:
a transfer shaft arranged perpendicular to the truck central axis and configured to transmit the torque of the drive unit from one of the first and second guide rails to the other guide rail of the first and second guide rails.

19. The pick-up truck of claim 15, wherein the drive unit includes a screw drive or a rack and pinion.

20. A cargo management assembly for moving objects in a bed of a pick-up truck arranged along a pick-up truck central axis, the bed of the pick-up truck including:
a first side-wall and a second side-wall, each arranged parallel to the pick-up truck central axis, and a floor, together define a width, a length, and a height of the pick-up truck bed, and wherein the bed defines a wheelhouse extending over a driven wheel and intruding into the width of the bed;
the cargo management assembly comprising:
a first guide rail arranged along the first side-wall and a second guide rail arranged along the second side-wall;
a panel arranged between the first and second side-walls, transverse to the pick-up truck central axis, and movably mounted on a panel axis to each of the first guide rail and the second guide rail; and
a mechanism configured to shift the panel along the first and second guide rails;
wherein the panel is configured to pivot on the panel axis with respect to the first and second guide rails or the panel includes a collapsible section, each configured to permit the panel to traverse over and clear the wheelhouse.
